(19) United States
(12) Patent Application Publication
(10) Pub. No.: US 2026/0244056 A1
(43) Pub. Date: Aug. 20, 2026

(54) LIQUID CRYSTAL DISPLAY DEVICE

(71) Applicant: SHARP KABUSHIKI KAISHA, Osaka (JP)

(72) Inventor: TETSUO FUKAYA, Osaka (JP)

(21) Appl. No.: 19/535,172

(22) Filed: Feb. 10, 2026

(30) Foreign Application Priority Data
Feb. 14, 2025 (JP) 2025-022393

(51) Int. Cl. G02F 1/1362; G02F 1/1368

(52) U.S. Cl. CPC G02F 1/136209; G02F 1/136222; G02F 1/136286; G02F 1/1368

(57) ABSTRACT

In a liquid crystal display device, a first substrate includes a display region and a frame region disposed around the display region, a first wiring line, a second wiring line, a picture element electrode electrically connected to the second wiring line via a switching element, and a counter electrode are disposed in the display region, a driver circuit connected to the first wiring line is disposed in the frame region, the second substrate includes a first light blocking member overlapping the driver circuit in a plan view, a color filter layer including a plurality of color filters, and a second light blocking member disposed between the first light blocking member and the color filter layer, the first light blocking member is a light blocking member formed of a metal and is ground-connected, and the first light blocking member and the second light blocking member are electrically independent of each other.

### CROSS-REFERENCE TO RELATED APPLICATIONS

This application claims the benefit of priority to Japanese Patent Application Number 2025-022393 filed on Feb. 14, 2025. The entire contents of the above-identified application are hereby incorporated by reference.

### BACKGROUND

### Technical Field

The disclosure, which will be described below, relates to a liquid crystal display device.

A liquid crystal display device is a display device in which a liquid crystal composition is used for display. In a typical display system of a liquid crystal display device, a light transmission amount is controlled by applying a voltage to a liquid crystal composition enclosed between a pair of substrates to change the alignment state of liquid crystal molecules in the liquid crystal composition according to the applied voltage. Such liquid crystal display devices make use of merits such as a thin, lightweight design and low power consumption, and thus are used in a wide range of fields.

For example, JP 2009-265484 A discloses a liquid crystal display device in which a scanning line lead line is covered with a shield electrode formed in the same layer as a counter electrode, and studies have been made to prevent a phenomenon in which the inside of a counter substrate is charged due to the influence of a gate voltage applied to the scanning line lead line and a white spot occurs in the vicinity of a screen in an IPS type liquid crystal display device.

Further, JP 2016-024288 A discloses a liquid crystal display device including a counter electrode provided in a frame region of a counter substrate and overlapping with an entire inspection circuit or protection circuit in a plan view, and in a liquid crystal display device of a transverse electrical field type, studies have been made to curb display unevenness occurring in a display region in the vicinity of a connection portion between a wiring line layer of the inspection circuit, protection circuit, or the like and a gate wiring line.

Further, JP 2016-126341 A discloses a liquid crystal display device and a method of manufacturing the same which are capable of preventing an electrostatic surge (ESD surge) from flowing into a liquid crystal display panel by designing a black matrix to be doubled.

### SUMMARY

A substrate on which switching elements such as a plurality of thin film transistors (TFTs) are disposed is also referred to as a TFT substrate, and in the related art, a gate driver for driving the switching elements has been disposed in a frame region of a liquid crystal display device as an integrated circuit (IC) chip. However, in recent years, as one of techniques for narrowing the frame of a liquid crystal display device, integrally forming a gate drive circuit (also referred to as a gate driver) on a TFT substrate has been considered (see, for example, International Publication No. 2011/104945). The gate driver integrally formed on the TFT substrate is also referred to as a gate driver monolithic.

According to the study of the present inventor, in a liquid crystal display device in which a gate driver monolithic is disposed in a frame region, display unevenness may occur in which a region of a display region adjacent to the frame region appears whiter than a central portion of the display region. In addition, according to the study of the present inventor, when high-frequency driving such as at 240 Hz is performed, the waveform of a scanning signal becomes dull, and the switching elements disposed for respective picture elements cannot be sufficiently charged in some cases.

The disclosure has been made in view of the above circumstances, and an object thereof is to provide a liquid crystal display device capable of curbing display unevenness, curbing insufficient charging of picture elements even in high-frequency driving, and obtaining a higher transmittance.

(1) An embodiment of the disclosure is a liquid crystal display device including a first substrate, a second substrate, and a liquid crystal layer sandwiched between the first substrate and the second substrate, in which the first substrate includes a display region and a frame region disposed around the display region, a first wiring line extending in a first direction, a second wiring line extending in a second direction intersecting the first direction, a picture element electrode electrically connected to the second wiring line via a switching element, and a counter electrode facing the picture element electrode are disposed in the display region, a driver circuit connected to the first wiring line is disposed in the frame region, the second substrate includes a first light blocking member disposed overlapping the frame region in a plan view and overlapping at least the driver circuit, a color filter layer including a plurality of color filters disposed overlapping the display region, and a second light blocking member disposed between the first light blocking member and the color filter layer, the first light blocking member is a light blocking member formed of a metal and is ground-connected, and the first light blocking member and the second light blocking member are electrically independent of each other.

(2) In the liquid crystal display device according to an embodiment of the disclosure, in addition to the configuration of (1), the first light blocking member and the second light blocking member are disposed with an interval therebetween.

(3) In the liquid crystal display device according to an embodiment of the disclosure, in addition to the configuration of (1) or (2), the second light blocking member is a light blocking member formed of a metal.

(4) In the liquid crystal display device according to an embodiment of the disclosure, in addition to the configuration of any one of (1) to (3), the second substrate further includes a third light blocking member disposed between the plurality of color filters in a plan view, and the third light blocking member is a light blocking member formed of a metal.

(5) In the liquid crystal display device according to an embodiment of the disclosure, in addition to the configuration of any one of (1) to (3), the second substrate further includes a third light blocking member disposed between the plurality of color filters in a plan view, and the third light blocking member is a light blocking member formed of a resin.

(6) In the liquid crystal display device according to an embodiment of the disclosure, in addition to the configuration of any one of (1) to (4), the first substrate further includes a fourth light blocking member disposed overlapping a region between the first light blocking member and the second light blocking member disposed with an interval therebetween in a plan view.

(7) In the liquid crystal display device according to an embodiment of the disclosure, in addition to the configuration of (1), (2), (4), (5), or (6), the second light blocking member is a light blocking member formed of a resin.

(8) In the liquid crystal display device according to an embodiment of the disclosure, in addition to the configuration of (7), the first light blocking member and the second light blocking member are in contact with each other, and the second light blocking member has a resistance of 10¹⁴ Ω/cm or more.

(9) In the liquid crystal display device according to an embodiment of the disclosure, in addition to the configuration of any one of (1) to (8), the second substrate includes a conductive member electrically connected to the first light blocking member.

(10) In the liquid crystal display device according to an embodiment of the disclosure, in addition to the configuration of any one of (1) to (9), the second substrate includes a transparent conductive layer electrically connected to the conductive member on the surface opposite to the liquid crystal layer.

According to the disclosure, it is possible to provide a liquid crystal display device capable of curbing display unevenness, curbing insufficient charging of picture elements even in high-frequency driving, and obtaining a higher transmittance.

### BRIEF DESCRIPTION OF DRAWINGS

The disclosure will be described with reference to the accompanying drawings, wherein like numbers reference like elements.

FIG. 1 is a schematic plan view of a liquid crystal display device 1-1 according to a first embodiment.

FIG. 2 is a schematic plan view of a first substrate used in the liquid crystal display device illustrated in FIG. 1.

FIG. 3 is an enlarged schematic plan view of a corner portion of the liquid crystal display device surrounded by a dotted line in FIG. 1.

FIG. 4 is a schematic cross-sectional view taken along line X1-X2 in FIG. 3.

FIG. 5 is a schematic cross-sectional view taken along line X3-X4 in FIG. 3.

FIG. 6 is a schematic plan view illustrating a liquid crystal display device 1-2 according to a modification example of the first embodiment.

FIG. 7 is an enlarged schematic plan view of a corner portion of the liquid crystal display device surrounded by a dotted line in FIG. 6.

FIG. 8 is a schematic cross-sectional view taken along line X5-X6 in FIG. 7.

FIG. 9 is an enlarged schematic plan view of a corner portion of a liquid crystal display device 2-1 according to a second embodiment.

FIG. 10 is a schematic cross-sectional view taken along line X7-X8 in FIG. 9.

FIG. 11 is a schematic cross-sectional view taken along line X9-X10 in FIG. 9.

FIG. 12 is an enlarged schematic plan view of a corner portion of a liquid crystal display device 2-2 according to a modification example of the second embodiment.

FIG. 13 is a schematic cross-sectional view taken along line X11-X12 in FIG. 12.

FIG. 14 is a schematic cross-sectional view of a liquid crystal display device R1 according to Comparative Example 1.

FIG. 15 is a schematic cross-sectional view of a liquid crystal display device R2 according to Comparative Example 2.

FIG. 16 is a schematic cross-sectional view of a liquid crystal display device R3 according to Comparative Example 3.

FIG. 17 is a schematic plan view illustrating display unevenness occurring in a liquid crystal display device according to Comparative Example 2.

### DESCRIPTION OF EMBODIMENTS

The disclosure will be described in detail below through the presentation of embodiments with reference to the drawings, but the disclosure is not limited only to these embodiments.

### Definitions of Terms

In this specification, an “observation face side” means the side closer to an observer with respect to a screen (display surface) of a liquid crystal display device, and a “back face side” means the side farther from the observer with respect to the screen (display surface) of the liquid crystal display device.

In this specification, the expression “two axes (directions) are orthogonal to each other” means that an angle (absolute value) formed between the axes is in a range of 90±3°, is preferably in a range of 90±1°, is more preferably in a range of 90±0.5°, and is particularly preferably 90° (completely orthogonal). Further, in this specification, the expression “two axes (directions) are parallel to each other” means that an angle (absolute value) formed between the axes is in a range of 0±3°, is preferably in a range of 0±1°, is more preferably in a range of 0±0.5°, and is particularly preferably 0° (completely parallel).

### First Embodiment

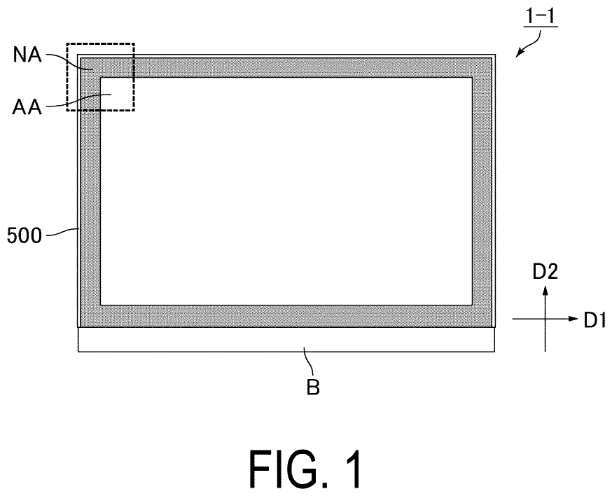

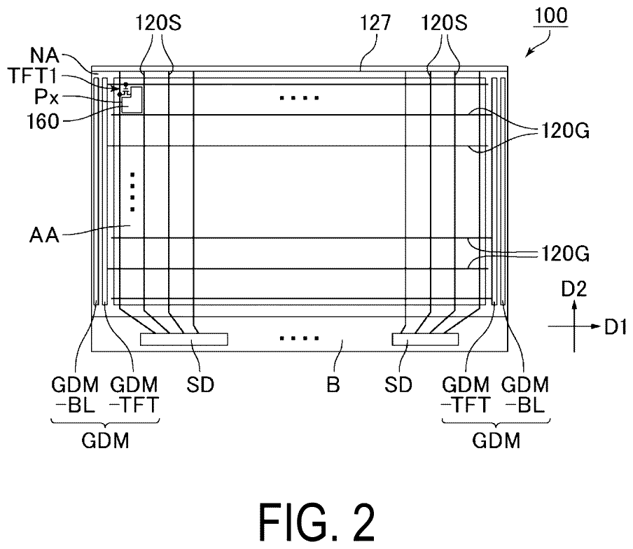

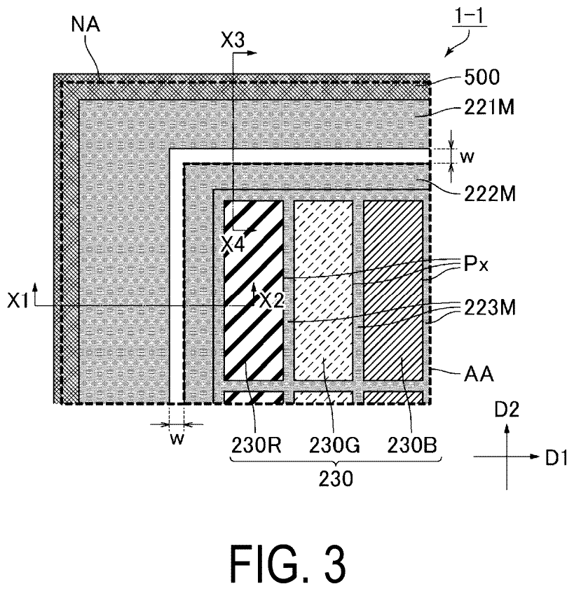

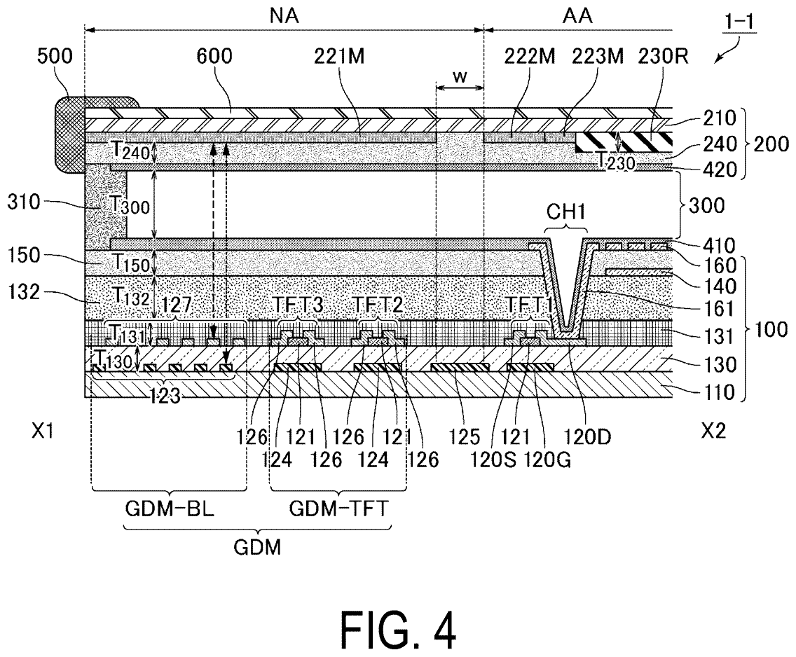

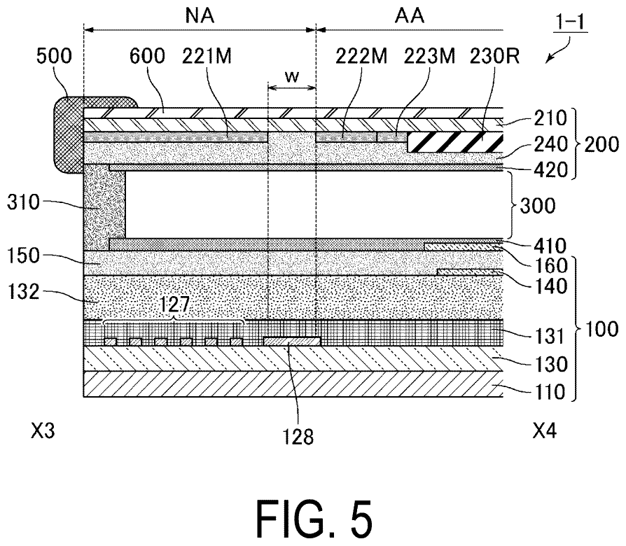

FIG. 1 is a schematic plan view of a liquid crystal display device 1-1 according to a first embodiment. FIG. 2 is a schematic plan view of a first substrate used in the liquid crystal display device illustrated in FIG. 1. FIG. 3 is an enlarged schematic plan view of a corner portion of the liquid crystal display device surrounded by a dotted line in FIG. 1. FIG. 4 is a schematic cross-sectional view taken along line X1-X2 in FIG. 3. FIG. 5 is a schematic cross-sectional view taken along line X3-X4 in FIG. 3. In this specification, in the schematic plan view, the cross-sectional view, and the like of the liquid crystal display device, regions overlapping a display region AA and a frame region NA of a first substrate 100 illustrated in FIG. 2 in a plan view are also referred to as a display region AA and a frame region NA, respectively. The liquid crystal display device according to the first embodiment includes the first substrate 100, a second substrate 200, and a liquid crystal layer 300 sandwiched between the first substrate 100 and the second substrate 200. The first substrate 100 may be on the back face side, and the second substrate 200 may be on the observation face side.

As illustrated in FIGS. 1 and 2, a liquid crystal display device 1-1 and the first substrate 100 according to the first embodiment include, in a plan view, the display region AA and the frame region NA disposed around the display region AA. Although FIG. 1 illustrates a case where the frame region NA is disposed to surround the display region AA, the frame region NA may be disposed at least at one outer edge of the display region AA, and the display region AA may not be surrounded by the frame region NA. As illustrated in FIG. 2, the display region AA includes a plurality of picture elements Px, and is a region where a desired image or the like is displayed. Various wiring lines, switching elements, and the like for driving the plurality of picture elements are disposed in the frame region NA. In this specification, the frame regions NA disposed above, below, on the left side, and on the right side of the display region AA are also referred to as an upper frame region, a lower frame region, a left frame region, and a right frame region, respectively. The first substrate 100 may include a terminal region B below the lower frame region. In the terminal region B, a source driver SD, a wiring line for driving a GDM to be described later, and the like are disposed.

As illustrated in FIG. 2, a first wiring line 120G extending in a first direction D1 and a second wiring line 120S extending in a second direction D2 intersecting the first direction D1 are disposed in the display region AA. The first wiring line 120G may be a gate wiring line, and the second wiring line may be a source wiring line. A plurality of gate wiring lines 120G are provided on a first support substrate 110 so as to extend parallel to each other and in the first direction D1 in a plan view. A plurality of source wiring lines 120S are provided to extend in parallel with each other and in the second direction D2 so as to intersect the respective gate wiring lines 120G via a first insulating layer (gate insulating layer) 130. The plurality of gate wiring lines 120G and the plurality of source wiring lines 120S are formed in a lattice shape as a whole to separate the picture elements Px. A TFT 1 serving as a switching element is disposed at an intersection between each gate wiring line 120G and each source wiring line 120S. As illustrated in FIG. 4, the display region AA includes picture element electrodes 160 electrically connected to the second wiring lines 120S via the switching element TFT 1, and counter electrodes 140 facing the picture element electrodes 160.

A dummy picture element may be disposed near a boundary between the display region AA and the frame region NA. The dummy picture element is a picture element used for adjusting the timing of a common signal and a gate signal, and does not directly contribute to image display or the like. The dummy picture element may not include a pixel electrode disposed therein, and may overlap a light blocking member disposed on the second substrate 200 without overlapping a color filter layer 230 in a plan view.

Here, the liquid crystal display device 1-1 is preferably in a horizontal alignment mode in which the control is performed by rotating the alignment of the liquid crystal molecules mainly in a plane parallel to the substrate plane, for the reason that a wide viewing angle characteristic is easily obtained. Examples of the horizontal alignment mode include an in-plane switching (IPS) mode and a fringe field switching (FFS) mode. In the IPS mode liquid crystal display device, a pair of comb-shaped picture element electrode 160 and counter electrode 140 are disposed to face each other on the same plane for one picture element. In the FFS mode liquid crystal display device, the picture element electrode 160 and the counter electrode 140 are layered with an insulating layer interposed therebetween. Hereinafter, the FFS mode liquid crystal display device will be described, but the liquid crystal display device of the disclosure is not limited to such a configuration.

The first substrate 100 includes, for example, the first support substrate 110, the gate wiring line 120G, the first insulating layer 130, the source wiring line 120S, a second insulating layer 131, the counter electrode 140, a fourth insulating layer 150, and a picture element electrode 160 in this order from the back face side toward the observation face side. A third insulating layer 132 may be further provided between the second insulating layer 131 and the counter electrode 140. The first support substrate 110 and a second support substrate 210 to be described later are substrates having insulating properties, and are preferably transparent substrates such as glass substrates and plastic substrates.

The picture element electrode 160 is preferably disposed for each picture element. The picture element electrode 160 may be provided with a slit. The picture element electrode 160 includes a plurality of linear electrodes, and a region between the plurality of linear electrodes is a slit. The plurality of linear electrodes may be configured such that one-side ends thereof are connected to each other or both-side ends thereof are connected to each other.

The counter electrode 140 may be a planar electrode. The planar electrode refers to an electrode in which no slit or the like is provided in a region overlapping an optical opening of a picture element to be described later at least in a plan view. The counter electrode 140 may be disposed for each picture element Px, or may be disposed across the plurality of picture elements Px regardless of the boundaries between the plurality of picture elements Px.

The counter electrode 140 and the picture element electrode 160 are preferably made of a transparent conductive material. Examples of the transparent conductive material include indium tin oxide (ITO) and indium zinc oxide (IZO).

The liquid crystal display device may be of a transmissive type, a reflective type, or a transflective type. FIG. 4 and the like illustrate a transmissive liquid crystal display device. Although not illustrated in the drawing, when the liquid crystal display device is a reflective or transflective liquid crystal display device, a TFT substrate preferably includes a reflective layer in a display region. The reflective layer may be disposed to be closer to, for example, the back face side (support substrate 110) side than the counter electrode 140 with an insulating layer interposed therebetween. The reflective layer may also include an opening provided at a position overlapping each pixel. In the case of a transflective type, light emitted from a backlight passes through the opening and is emitted to the observation face side, whereby transmissive display can be performed.

The reflective layer is preferably formed of a metal having high reflectivity, and may include a single or multiple metal layers formed of, for example, aluminum or silver. The reflective layer may be a layered body of the metal layer and a transparent conductive layer. As the material of the transparent conductive layer, a known transparent conductive material such as ITO can be used.

Each of the plurality of picture elements Px is provided with an optical opening through which light passes. When the liquid crystal display device is a transmissive type, the optical opening transmits light incident from the back face side of the second substrate 200 toward the observation face side of the first substrate 100. When the liquid crystal display device is a reflective type, the optical opening transmits incident light that is incident from the observation face side (outside) of the first substrate 100 and reflected light that is the incident light reflected inside the liquid crystal display device and emitted toward the outside of the liquid crystal display device. The optical opening may overlap a member having transparency such as a polarizer or a color filter in a plan view.

The switching element TFT 1 is a switching element used to switch on and off the picture element, and may be, for example, a thin film transistor (TFT). The TFT 1 is, for example, a three-terminal switch including gate electrodes protruding from the gate wiring line 120G, source electrodes protruding from the source wiring line 120S, drain electrodes 120D connected to the picture element electrodes 160, and a semiconductor layer 121. The picture element electrodes 160 are electrically connected to the drain electrodes 120D via contact holes CH1 formed to penetrate the second insulating layer 131, the third insulating layer 132, and the fourth insulating layer 150.

The source electrode and the drain electrode 120D may be provided in the same source metal layer as the source wiring line 120S, and the gate electrode may be provided in the same gate metal layer as the gate wiring line 120G. The gate electrode is a part of the gate wiring lines 120G, and may be denoted by 120G in the drawings. The source electrode is a part of the source wiring line 120S, and may be denoted by 120S in the drawings.

Examples of materials for the gate metal layer and the source metal layer include metals such as copper, titanium, aluminum, molybdenum, and tungsten, and alloys thereof. The gate metal layer and the source metal layer may be a single layer or a plurality of layers of the above-described metal or alloy.

A common potential kept at a constant potential may be supplied to the counter electrode 140. When a scanning signal is input from a driver circuit (gate driver) to the gate wiring line 120G, the semiconductor layer 121 of the TFT 1 disposed in the corresponding picture element is brought into electrical conduction to turn on the TFT 1, and the picture element electrodes 160 are electrically connected to the second wiring line 120S via the TFT 1, whereby a data signal is written from the source wiring line 120S to the picture element electrodes 160. By applying a voltage between the counter electrode 140 and the picture element electrode 160, a transverse electrical field (fringe electrical field) is generated in the liquid crystal layer 300, and thus the alignment of the liquid crystal molecules can be controlled.

The semiconductor layer 121 of the TFT 1 is formed of, for example, amorphous silicon or an oxide semiconductor containing at least one metal element selected from the group consisting of indium, gallium, and zinc. The oxide semiconductor is formed of an In—Ga—Zn—O based oxide semiconductor (IGZO), or the like.

A driver circuit connected to the first wiring line is disposed in the frame region NA. When the first wiring line is a gate wiring line, the driver circuit is also referred to as a gate driver. It is preferable that the gate driver be a gate driver monolithic (GDM) integrally formed on the first substrate. In the GDM, IC chips and the like are not disposed on the TFT substrate, but, for example, the TFT 1 configuring the display region described above, the wiring lines such as the gate wiring lines 120G and the source wiring lines 120S for driving the TFT 1, and the gate driver are formed on the TFT substrate. The gate wiring line 120G extending in the frame region NA is also referred to as a gate lead-out wiring line, and the source wiring line 120S extending in the frame region NA is also referred to as a source lead-out wiring line.

The configuration of the GDM is not particularly limited, and for example, the configuration disclosed in WO 2011/104945 A or the like can be adopted. The GDM may include, for example, a plurality of shift registers for sequentially driving a plurality of gate wiring lines 120G disposed in the display region AA, and a plurality of bus lines 123 and 127 for driving the shift registers. Although not illustrated in the drawing, one shift register corresponds to one gate wiring line 120G and is electrically connected to the gate wiring line 120G by a connection wiring line. The shift register outputs a scanning signal of a predetermined value to the gate wiring line 120G at a predetermined timing. In this specification, a region where the plurality of shift registers are disposed is also referred to as a TFT region GDM-TFT, and a region where the plurality of bus lines are disposed is also referred to as a wiring line region GDM-BL.

One shift register may include a plurality of circuits in which a plurality of TFTs (a TFT 2 and a TFT 3 in the drawing) are respectively disposed. Two or more TFTs may be included depending on the number of circuits. The TFT 2 and the TFT 3 may have the same configuration as the TFT 1 disposed in the display region, and each include, for example, a gate electrode 124, a gate insulating layer (first insulating layer) 130, a semiconductor layer 121, a source electrode 126, a drain electrode, a second insulating layer 131, and the like.

Examples of the plurality of bus lines 123 and 127 include a plurality of clock signal lines, a start pulse signal line for supplying a pulse signal to a circuit to be driven first, a reset signal line for resetting the state of a shift register, a low-level power source line for supplying a low-level potential, a high-level power source line for supplying a potential higher than the low-level potential, a gate wiring line 120G extending in the frame region NA, a source wiring line 120S extending in the frame region NA, and the like. The plurality of bus lines are connected to the circuits (TFT 2, TFT 3, and the like) included in the shift register, and supply clock signals for inputting operation timings to the circuits. For example, a voltage of −12 V to −2 V is applied to the low-level power source line, and a voltage of +12 V to +24 V is applied to the high-level power source line.

The plurality of bus lines 123 and 127 may be disposed in the frame region NA. The plurality of source wiring lines 120S may be connected to the source driver SD via source lead-out wiring lines. The source driver SD may be disposed in, for example, the terminal region B. The plurality of bus lines 123 and 127 may include source wiring lines for panel inspection. The panel inspection source wiring line is a wiring line used for confirming the behavior of the liquid crystal display device, for example, during the manufacture of the liquid crystal display device, before shipment, or during repair, and is a wiring line that is not used during normal display of the liquid crystal display device. The source wiring lines for panel inspection may be extended from the upper frame region of the liquid crystal display device to at least one of the left frame region and the right frame region and connected to the source driver in the terminal region B, for example, as illustrated in FIGS. 2, 4, 5, and the like.

The first insulating layer 130, the second insulating layer 131, and the fourth insulating layer 150 are preferably inorganic insulating films (PAS). The inorganic insulating film may be, for example, an inorganic insulating film containing silicon nitride (SiNx) or silicon oxide (SiO₂), or a layered body thereof.

The third insulating layer 132 is preferably an organic insulating film (JAS). As the organic insulating film, for example, an organic insulating film containing an acrylic resin, an organic insulating film containing a polyimide resin, an organic insulating film containing a novolac resin, or a layered body thereof can be used.

The second substrate 200 includes a color filter layer 230 overlapping the display region AA in a plan view, and is also referred to as a color filter substrate. As a specific configuration of the second substrate 200, for example, as illustrated in FIGS. 4 and 5, a configuration in which the second support substrate 210 is provided, and a first light blocking member 221M, a second light blocking member 222M, and a color filter layer 230 are provided on the liquid crystal layer side of the second support substrate 210 is exemplified. In FIGS. 4 and 5, a red color filter 230R is illustrated as the color filter layer 230.

The color filter layer 230 includes a plurality of color filters. The color filter layer 230 includes, for example, a red color filter 230R, a green color filter 230G, and a blue color filter 230B. The arrangement of the color filters of the respective colors is not particularly limited, and may be, for example, a stripe arrangement in which color filters of different colors are disposed along one of the first direction and the second direction, and color filters of the same color are disposed along the other direction. A color filter of one color is disposed to overlap one picture element Px. FIG. 3 illustrates a case where color filters of different colors are disposed in the first direction D1 and color filters of the same color are disposed in the second direction D2. In general, a combination of the red color filter 230R, the green color filter 230G, and the blue color filter 230B is taken as one display unit, and is also referred to as a pixel. By mixing colors while controlling the amount of light passing through the color filter of each color for each picture element, a desired color is obtained in the pixel.

The red color filter 230R, the green color filter 230G, and the blue color filter 230B are obtained by, for example, curing a resin composition containing pigments of the respective colors. The pigment and resin composition are not particularly limited, and those commonly used in the field of liquid crystal display devices can be used.

The second substrate 200 includes a first color filter and a second light blocking member 222M. As illustrated in FIG. 3, the first light blocking member 221M is disposed to overlap the frame region NA in a plan view. As illustrated in FIG. 4, the first light blocking member 221M is disposed to overlap at least the driver circuit GDM. The first light blocking member 221M is a light blocking member formed of a metal and is ground-connected. The second light blocking member 222 is disposed between the first light blocking member 221M and the color filter layer 230, and the first light blocking member 221M and the second light blocking member 222 are electrically independent of each other.

The first light blocking member 221M and the second light blocking member 222 being electrically independent of each other refers to a state where the first light blocking member 221M and the second light blocking member 222 are insulated from each other, and examples of the state include a case where the first light blocking member 221M and the second light blocking member 222 are disposed via an insulator, a case where the second light blocking member 222 is an insulator, and the like. For example, referring to FIG. 4, it can be said that the first light blocking member 221M and the second light blocking member 222 are insulated from each other by the first support substrate 110 and/or an overcoat layer 240. A case where the second light blocking member is an insulator will be described in detail in a second embodiment. Whether the first light blocking member 221M and the second light blocking member 222 are electrically independent of each other can be confirmed by measuring a resistance value, a voltage, or the like of each of the first light blocking member 221M and the second light blocking member 222 by using, for example, a general digital multimeter or the like.

In a liquid crystal display device 1-1 according to the first embodiment, the first light blocking member 221M and the second light blocking member 222M are disposed with an interval therebetween, and thus the first light blocking member 221M and the second light blocking member 222M can be electrically independent of each other. In this specification, a region between the first light blocking member 221M and the second light blocking member 222 disposed with an interval W is also referred to as a light blocking member non-forming region.

Here, as described above, a high voltage is applied to the high-level power source line, the shift register, and the like included in the GDM. In addition, gate voltage leakage may occur from a plurality of bus lines including a gate lead-out wiring line or the like extending from the gate wiring line 120G to the frame region NA. Due to these factors, when the first light blocking member 221M is not disposed, a member such as the color filter layer 230 disposed on the second substrate 200 may be charged, and such charging is likely to occur particularly near a boundary between the display region AA and the frame region NA in which the driver circuit is disposed. When these members are charged, an unnecessary vertical electrical field is generated in the liquid crystal layer 300, and particularly in a liquid crystal display device of a horizontal alignment mode, the alignment of liquid crystal molecules is disturbed in a region of the display region AA which is adjacent to the frame region NA due to the unnecessary vertical electrical field generated in the liquid crystal layer 300, and display unevenness that appears whiter than the central portion of the display region AA may occur.

In the liquid crystal display device of the present embodiment, the first light blocking member 221M formed of a metal, which is disposed to overlap the driver circuit GDM and is ground-connected, and the second light blocking member 222 disposed to overlap the display region AA are electrically independent of each other. With such a configuration, it is possible to curb charging of members disposed on the second substrate 200 side such as the color filter layer 230. As a result, it is possible to curb display unevenness in the region of the display region AA which is adjacent to the frame region NA. Further, since an unnecessary vertical electrical field is less likely to be generated in the liquid crystal layer, a high transmittance is obtained. By disposing the first light blocking member 221M on the second substrate 200 side, distances from the first light blocking member 221M to the GDM and the plurality of bus lines 123 and 127 disposed on the first substrate 100 can be increased, and the electrostatic capacitance formed between the first light blocking member 221M, the GDM, and the plurality of bus lines 123 and 127 can be reduced. As a result, a time constant for each wiring line of the plurality of bus lines 123 and 127 can be reduced, and the waveform of a scanning signal can be prevented from becoming dull even in high-frequency driving, making it possible to prevent the picture element from being insufficiently charged.

The first light blocking member 221M is disposed to overlap at least the driver circuit. FIG. 2 illustrates a case where the driver circuit GDM is disposed in the right frame region and the left frame region of the first substrate 100. In this case, the first light blocking member 221M may be disposed to overlap the left and right frame regions, but may be disposed to further overlap the upper frame region.

The second light blocking member 222 is disposed between the first light blocking member 221M and the color filter layer 230 in a plan view. The second light blocking member 222 may be disposed at least between the frame region on the side where the driver circuit is disposed and the color filter layer 230, and is preferably disposed with an interval from the first light blocking member 221M disposed to overlap the frame region on the side where the driver circuit is disposed. When the driver circuit GDM is disposed in the left frame region and the right frame region of the first substrate 100, the second light blocking member 222 is preferably disposed between the first light blocking member 221M disposed to overlap the left frame region and the color filter layer 230 and between the first light blocking member 221M disposed to overlap the right frame region and the color filter layer 230.

The first light blocking member 221M may be disposed to overlap all four frame regions of the left side, the right side, the upper side, and the lower side. When the first light blocking member 221M is disposed to overlap all the four frame regions, the second light blocking member 222M may be disposed to surround the color filter layer 230, and the first light blocking member 221M may be disposed to surround the second light blocking member 222M with an interval therebetween.

The first light blocking member 221M is a light blocking member formed of a metal. As the light blocking member formed of a metal, a member having a low surface resistivity and a low light transmittance is preferable, and a member that appears black is suitably used. The first light blocking member 221M preferably has a lower surface resistivity than the surface resistivity of a transparent electrode formed of ITO or the like, and may have a surface resistivity of, for example, 10Ω/□ or less. The first light blocking member 221M more preferably has a surface resistivity of 5Ω/□ or less, still more preferably 1Ω/□ or less, and particularly preferably 0.15Ω/□ or more and 0.1Ω/□ or less. The surface resistivity can be measured by a method according to JIS K7194:1994.

Examples of the material of the light blocking member formed of a metal include metals such as molybdenum, tungsten, titanium, and tantalum, nitrides of the metals, and alloys containing the metals or the nitrides. The light blocking member formed of a metal may be a single layer or a layered body of two or more layers. Examples of the layered body of two or more layers include a single-layer or multilayer metal film containing the metals, the nitrides of the metal, or alloys thereof, a layered body of the single-layer or multilayer metal film and a nitride film or an oxide film (hereinafter, also referred to as a nitride film or the like), and the like, and more specifically, a layered body of a metal film containing titanium and a nitride film or the like, a layered body of a metal film containing molybdenum and a nitride film or the like, a layered body of a metal film containing tungsten and a nitride film or the like, and the like. Examples of the nitride film include silicon nitride and silicon oxide.

As the light blocking member formed of a metal, a silver oxide film may be used. By using the silver oxide film, a black light blocking member having low resistance can be formed. The thin film of silver oxide may be formed by, for example, a method in which silver is used as a sputtering target, sputtering is performed while introducing oxygen to form a thin film of silver oxide, sputtering is then performed while blocking oxygen, and finally oxygen is reintroduced to form a thin film of silver oxide. The obtained silver oxide thin film is patterned using, for example, a mixed solution of ammonia water and hydrogen peroxide water, and thus only silver and silver oxide can be selectively etched at once.

It is preferable that the second substrate 200 further include third light blocking members 223 disposed between the plurality of color filters in a plan view. The third light blocking member 223 may be disposed between the color filters adjacent to each other in the first direction D1 or between the color filters adjacent to each other in the second direction D2. It is preferable that the third light blocking member 223 be disposed at least between color filters of different colors. For example, in the case of stripe arrangement as illustrated in FIG. 3, it is preferable that the third light blocking member 223 be disposed in the second direction D2 between the color filters adjacent to each other in the first direction D1. With such an arrangement, color mixing between color filters of different colors can be prevented. The third light blocking member 223 may be disposed both between the color filters adjacent to each other in the first direction D1 and between the color filters adjacent to each other in the second direction D2. In this case, the third light blocking member 223 is disposed in a lattice shape and is disposed outside the optical opening of each picture element. The third light blocking member 223 is preferably disposed to overlap one of the gate wiring line 120G and the source wiring line 120S in the display region AA in a plan view, and more preferably disposed to overlap both of them.

As illustrated in FIG. 3, the third light blocking member 223 may be disposed to surround each color filter in a plan view. In this case, the third light blocking member 223 is disposed between the color filter layer 230 and the second light blocking member 222.

The second light blocking member 222 may be a light blocking member formed of a metal or a light blocking member formed of a resin, and the third light blocking member 223 may be a light blocking member formed of a metal or a light blocking member formed of a resin. In this specification, when the second light blocking member and the third light blocking member are each a light blocking member formed of a metal, they are described as a second light blocking member 222M and a third light blocking member 223M, respectively, and when they are each a light blocking member formed of a resin, they are described as a second light blocking member 222R and a third light blocking member 223R, respectively. In particular, when it is not necessary to distinguish whether the light blocking members are formed of a metal or a resin, they are referred to as the second light blocking member 222 and the third light blocking member 223, respectively.

In the first embodiment, a case where the first light blocking member 221M, the second light blocking member 222M, and the third light blocking member 223M are light blocking members formed of a metal is described. The light blocking member formed of a metal used for the second light blocking member 222M and the third light blocking member 223M may be the same as that used for the first light blocking member 221M. The light blocking members formed of a resin will be described below. When the second light blocking member 222M and the third light blocking member 223M are formed of the same material, a boundary between the second light blocking member 222M and the third light blocking member 223M is not visually distinguished.

From the viewpoint of reducing the number of steps of manufacturing the liquid crystal display device, it is preferable that the second light blocking member 222 and the third light blocking member 223 be also light blocking members formed of a metal. Since a light blocking member formed of a metal can be processed to be thinner than a light blocking member formed of a resin, flatness of the color filter layer is easily secured by using the light blocking member formed of a metal as the second light blocking member 222 and the third light blocking member 223. As a result, an alignment failure of the liquid crystal molecules is less likely to occur, and particularly, in a liquid crystal display device of a horizontal alignment mode, the luminance at the time of black display is lowered, and high contrast is obtained. In particular, in a transmissive or transflective liquid crystal display device, the disclosure is effective in a transmissive mode in which light emitted from a backlight is transmitted to the observation face side. Further, the light blocking member formed of a metal can be processed with higher accuracy than the light blocking member formed of a resin, and thus the aperture ratio of the picture element can be increased.

The second light blocking member 222 and the third light blocking member 223 may be formed of the same material as that of the first light blocking member 221M, and examples thereof include metals such as molybdenum, tungsten, titanium, and tantalum, nitrides of the metals, and alloys containing the metals or the nitrides. Examples of the second light blocking member 222 and the third light blocking member 223 include a single-layer or multilayer metal film exemplified in the first light blocking member 221M, a layered body of the single-layer or multilayer metal film and the nitride film or the like, the silver oxide film, and the like.

Hereinafter, an example of a method of manufacturing the second substrate 200 when the first light blocking member 221M, the second light blocking member 222M, and the third light blocking member 223M are light blocking members formed of a metal will be described. The first light blocking member 221M, the second light blocking member 222, and the third light blocking member 223 may be formed in the same layer, for example, may be formed on the second support substrate 210.

First, a metal film is formed on the second support substrate 210 by a sputtering method or the like using the material of the light blocking member formed of a metal. When a nitride film is layered on the metal film, the nitride film is formed on the metal film by a sputtering method or the like. Thereafter, a resist mask is formed in a region where the light blocking member is disposed by photolithography or the like. Specifically, the resist mask is formed in a region other than a region where the light blocking member is not formed between the first light blocking member 221M and the second light blocking member 222M, a region of the optical openings of the respective picture elements, and the like. Thereafter, the metal film and the nitride film are patterned by etching or the like. The etching may be dry etching or wet etching. Thereafter, the first light blocking member 221M, the second light blocking member 222M, and the third light blocking member 223M are formed by peeling off the resist mask.

The color filter layer 230 can be formed by a known method. For example, a method of sequentially forming resist materials of respective colors in a region (optical opening) surrounded by the third light blocking member 223 by spin coating, slit coating, or the like and patterning the resist materials by photolithography or the like is exemplified. Examples of the resist material include a photosensitive resin containing a colorant.

Here, it is preferable that the first substrate 100 further include a fourth light blocking member disposed to overlap a region (light blocking member non-forming region) between the first light blocking member 221M and the second light blocking member 222 disposed with an interval therebetween in a plan view. By disposing the fourth light blocking member, it is possible to prevent light incident from the back face side of the second substrate 200 from escaping to the observation face side from between the first light blocking member 221M and the second light blocking member 222. The material of the fourth light blocking member may be the same as those of the gate wiring line 120G and the source wiring line 120S. The fourth light blocking member may not be electrically connected to the driver, the signal line, the ground, or the like, and may be in a floating state in which the potential is independent. The fourth light blocking member may be disposed in the gate metal layer or may be disposed in the source metal layer. For example, the fourth light blocking member may be a light blocking member 125 disposed in the gate metal layer as illustrated in FIG. 4, or may be a light blocking member 128 disposed in the source metal layer as illustrated in FIG. 5.

The second substrate 200 may include a conductive member 500 electrically connected to the first light blocking member 221M. The conductive member 500 may be disposed on, for example, the side surface of the second substrate 200, and is preferably disposed along the outer edge of the frame region NA in which the driver circuit is disposed in a plan view. When the driver circuit is disposed in the left frame region and the right frame region of the first substrate 100 (see FIG. 2), the conductive member 500 may be formed along the outer edges of the left frame region and the right frame region of second substrate 200, but may be further formed along the outer edge of the upper frame region as illustrated in FIG. 1. The outer edge of the frame region NA refers to an edge on a side far from the display region AA in a plan view. As illustrated in FIGS. 4 and 5, the first light blocking member 221M may be formed up to the outer edge of the second substrate, and the first light blocking member 221M and the conductive member 500 are preferably electrically connected to each other at the outer edge.

The conductive member 500 can be formed of, for example, a conductive paste, solder, or the like. Examples of the conductive paste include a paste containing metal fine particles such as silver. The conductive paste may contain a binder resin, a dispersion medium such as an organic solvent, and the like.

The second substrate may include a transparent conductive layer 600 electrically connected to the conductive member 500 on a surface opposite to the liquid crystal layer 300. The transparent conductive layer 600 may be formed on a part of the surface of the second substrate on the side opposite to the liquid crystal layer 300, but is preferably formed on the entire surface of the surface of the second substrate on the side opposite to the liquid crystal layer 300. Examples of the material for the transparent conductive layer 600 include transparent conductive materials such as ITO and IZO. The first light blocking member 221M and the transparent conductive layer 600 are preferably electrically connected to each other via the conductive member 500. As illustrated in FIGS. 4 and 5, the conductive member 500 may be formed on a part of the surface of the transparent conductive layer 600 on the observation face side so as to overlap the outer edge of the transparent conductive layer 600 in a plan view.

The first light blocking member 221M may be ground-connected by the first light blocking member 221M itself, may be ground-connected via the conductive member 500, or may be ground-connected via the conductive member 500 and the transparent conductive layer 600. Examples of a method of grounding the first light blocking member 221M include a frame ground electrically connected to a metal frame or the like, a ground, and a method of setting a common potential, but the ground is preferable. The second light blocking member 222M may be in a floating state.

The second substrate 200 may further include an overcoat layer 240 covering the first light blocking member 221M, the second light blocking member 222M, and the color filter layer 230 on the liquid crystal layer 300 side. By disposing the overcoat layer 240, the surface of the second substrate 200 on the liquid crystal layer 300 side can be flattened, and impurities in the color filter layer 230 can be prevented from being eluted to the liquid crystal layer 300 side. The overcoat layer 240 also functions as a base of the second alignment film 420. Further, the thickness of the insulating layer present between the first light blocking member 221M and the plurality of bus lines, the GDM, and the like can be increased, and gate voltage leakage can be reduced.

Examples of the material of the overcoat layer 240 include a photocurable or thermosetting transparent resin. The photocurable transparent resin is preferably used together with, for example, a photopolymerization initiator, an additive, a solvent, and the like.

The liquid crystal layer 300 contains liquid crystal molecules. The amount of light passing through the liquid crystal layer 300 can be controlled by changing the alignment of the liquid crystal molecules in response to an electrical field generated in the liquid crystal layer 300 by a voltage applied between the counter electrode 140 and the picture element electrode 160.

The liquid crystal molecules may have a positive or negative value of dielectric constant anisotropy (Ac) as defined by the following Formula (L). The liquid crystal molecules having a positive dielectric constant anisotropy are also referred to as a positive-type liquid crystal, and the liquid crystal molecules having a negative dielectric constant anisotropy are also referred to as a negative-type liquid crystal. The liquid crystal layer 300 of the present embodiment preferably contains liquid crystal molecules having a positive value of Δε. Δε=(Dielectric constant in long axis direction)−(Dielectric constant in short axis direction) (L)

In the liquid crystal display device of the horizontal alignment mode, the liquid crystal molecules are preferably horizontally aligned by a regulating force of the first alignment film 410 and the second alignment film 420 to be described later in a state where no voltage is applied between the counter electrode 140 and the picture element electrode 160 (when no voltage is applied). In a state where a voltage is applied between the counter electrode 140 and the picture element electrode 160 (when no voltage is applied), the liquid crystal molecules preferably rotate in the in-plane direction in accordance with a transverse electrical field generated in the liquid crystal layer 300. The case where no voltage is applied also includes a case where a voltage lower than a threshold voltage of liquid crystal molecules is applied to the liquid crystal layer 300.

The liquid crystal display device may include a first alignment film 410 between the first substrate 100 and the liquid crystal layer 300, and a second alignment film 420 between the second substrate 200 and the liquid crystal layer 300. The first alignment film 410 and the second alignment film 420 are layers that have been subjected to an alignment process for controlling the alignment of liquid crystal molecules, and alignment films commonly used in the field of liquid crystal display devices can be used. Examples of the materials of the first alignment film 410 and the second alignment film 420 include polymers with a main chain, such as polyimide, polyamic acid, and polysiloxane. A photo-alignment film material having a photoreactive site (functional group) in the main chain or the side chain is suitably used. Examples of the photoreactive site include a cinnamate group, an azobenzene group, a chalcone group, a stilbene group, and a coumarin group.

The first alignment film 410 and the second alignment film 420 are preferably horizontal alignment films that can perform control so that the long axis of the liquid crystal molecules is aligned horizontally with respect to the first alignment film 410 and the second alignment film 420 when no voltage is applied. Here, horizontal alignment of the liquid crystal molecules means that a tilt angle of the liquid crystal molecules is preferably 0° or more and 5° or less, more preferably 0° or more and 3° or less, and even more preferably 0° or more and 1° or less. The tilt angle of the liquid crystal molecules refers to an angle at which the long axis (optical axis) of the liquid crystal molecules is inclined with respect to the surfaces of the first alignment film 410 and the second alignment film 420.

Although not illustrated in the drawing, the liquid crystal display device may further include a polarizer. When the liquid crystal display device is a transmissive or transflective liquid crystal display device, the liquid crystal display device may include a first linear polarizer on the side of the first substrate 100 opposite to the liquid crystal layer 300, and a second linear polarizer on the side of the second substrate 200 opposite to the liquid crystal layer 300. It is preferable that the absorption axis of the first linear polarizer and the absorption axis of the second linear polarizer be disposed to be orthogonal to each other. As the first and second linear polarizers, an absorption type linear polarizer generally used in the field of liquid crystal display devices can be used. It is preferable that the long axis of the liquid crystal molecules be disposed orthogonal or parallel to the absorption axis of the first linear polarizer when no voltage is applied to the liquid crystal layer 300, and this state is referred to as black display, and is a state where the luminance is the lowest (0 gray scale). When the liquid crystal display device is a reflective

type, it is preferable to include a circular polarizer on the side of the first substrate 100 opposite to the liquid crystal layer 300. The circular polarizer may be, for example, a layered body of the first linear polarizer and a λ/4 plate. When the liquid crystal display device is a transflective type, the first linear polarizer and the λ/4 plate may be layered on each other. When the liquid crystal display device includes the transparent conductive layer 600, the first polarizer or the circular polarizer may be disposed to be closer to the observation face side than the transparent conductive layer 600.

The λ/4 plate may be, for example, a retardation layer that imparts an in-plane retardation of 107.5 nm to 167.5 nm to light having a wavelength of 550 nm. Here, the retardation layer is a layer having a function of changing the state of incident polarized light by applying a retardation between two orthogonal polarized light components using a birefringent material or the like. As the λ/4 plate, a plate generally used in the field of liquid crystal display devices can be used, and a plate using a photopolymerizable liquid crystal material having a photopolymerizable group such as an acrylate group or a methacrylate group may be used, or a stretched polymer film may be used.

When the liquid crystal display device 1-1 is a transmissive or transflective liquid crystal display device, the liquid crystal display device 1-1 may further include a backlight (not illustrated) on the back face side (the side opposite to the liquid crystal layer 300) of the first substrate 100. The backlight is not particularly limited as long as it irradiates light toward the first substrate 100 side, and may be a direct type, an edge type, or any other type.

The liquid crystal display device of the present embodiment is configured with a plurality of members, such as a backlight, optical films such as a viewing angle widening film and a luminance enhancement film, and a bezel (frame), and some members may be incorporated into other members. Members other than those described above are not particularly limited to specific members and, because such members can be those commonly used in the field of liquid crystal display devices, descriptions thereof are omitted.

### Modification Example of First Embodiment

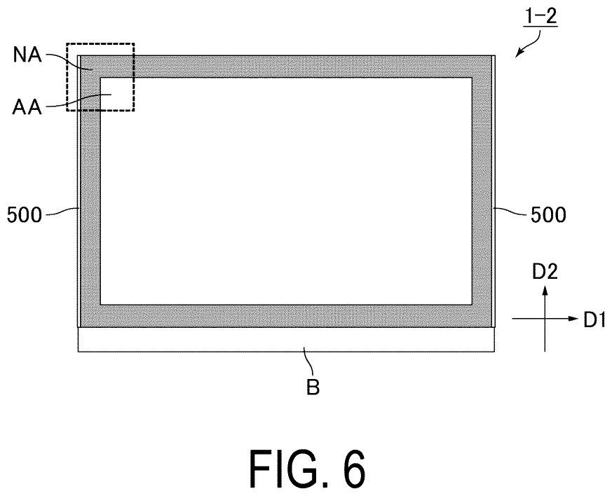

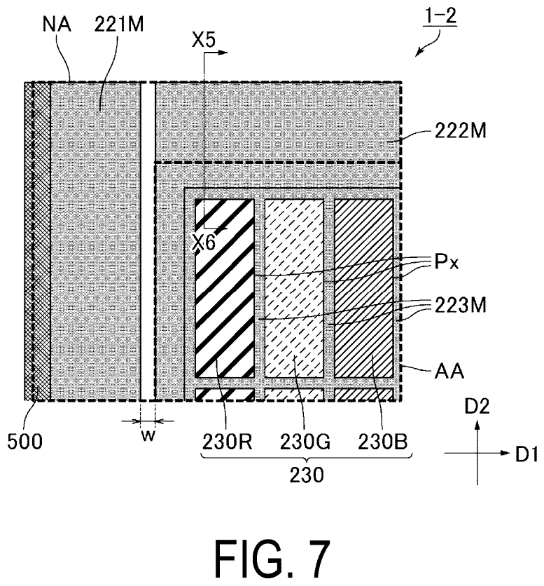

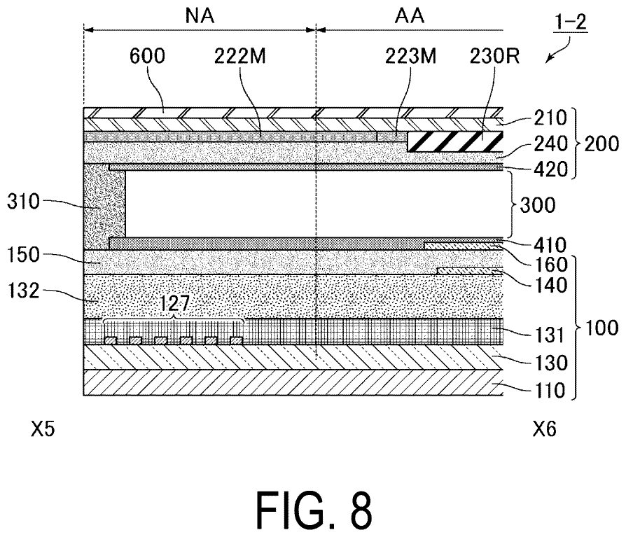

FIG. 6 is a schematic plan view of a liquid crystal display device 1-2 according to a modification example of the first embodiment. FIG. 7 is an enlarged schematic plan view of a corner portion of the liquid crystal display device surrounded by a dotted line in FIG. 6. FIG. 8 is a schematic cross-sectional view taken along line X5-X6 in FIG. 7. A schematic cross-sectional view taken along the first direction D1 including the left frame region of the liquid crystal display device 1-2 is the same as that in FIG. 4, and thus is omitted. The second embodiment is the same as the first embodiment except that the arrangement of the first light blocking member 221M and the second light blocking member 222M is different, and thus a repeated description will be omitted.

When the driver circuits such as the GDMs are disposed in the left and right frame regions, the first embodiment has exemplified a case where the conductive member 500 is disposed along the outer edges of the left frame region, the right frame region, and the upper frame region in a plan view, but as illustrated in FIG. 6, the conductive member 500 may be disposed along the outer edges of the left and right frame regions and may not be disposed at the outer edge of the upper frame region.

Further, in the first embodiment, the first light blocking member 221M is disposed to surround the second light blocking member 222M, but the first light blocking member 221M may not be disposed to overlap the upper frame region and/or the lower frame region, and as illustrated in FIG. 7, the first light blocking member 221M may be disposed up to the upper end of the frame region along the vertical direction of the liquid crystal display device 1-2.

The second light blocking member 222M may be disposed with an interval from the first light blocking member 221M overlapping the frame region in which the GDM is disposed, and as illustrated in FIG. 7, the second light blocking member 222M may be continuously disposed from the display region AA to the upper frame region. Although not illustrated in the drawing, the second light blocking member 222M may be continuously disposed from the display region AA to the lower frame region. In other words, in the modification example of the first embodiment, a light blocking member non-forming region may be provided between the first light blocking member 221M and the second light blocking member 222M, up to the upper end and the lower end of the liquid crystal display device 1-2.

Also in the modification example of the first embodiment, the first light blocking member 221M formed of a metal, which is disposed to overlap the frame region in which the GDM is disposed and is ground-connected, and the second light blocking member 222M are electrically independent of each other. In the modification example of the first embodiment, the first light blocking member 221M and the second light blocking member 222M may be disposed with an interval therebetween and electrically independent of each other, and the configuration is not limited to the configuration illustrated in FIG. 7.

### Second Embodiment

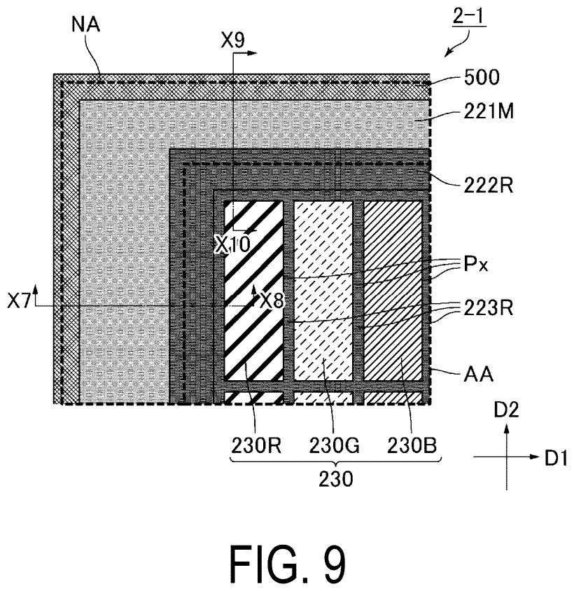

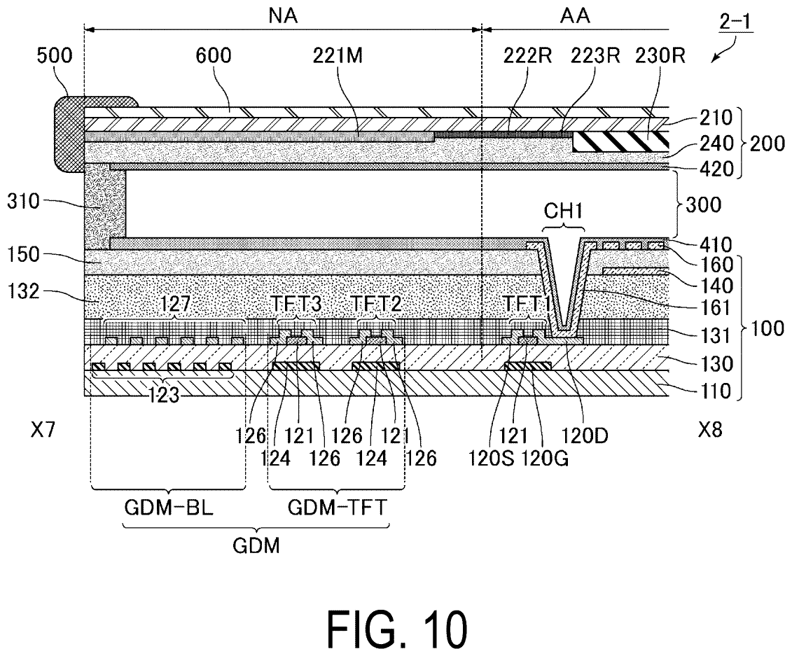

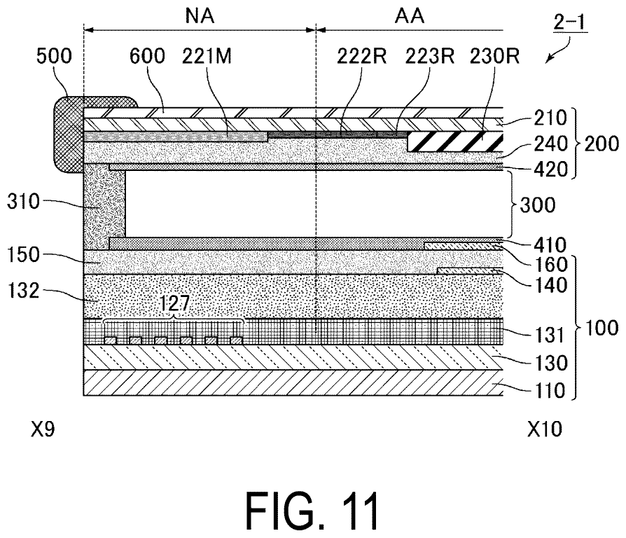

FIG. 9 is an enlarged schematic plan view of a corner portion of a liquid crystal display device 2-1 according to a second embodiment. FIG. 10 is a schematic cross-sectional view taken along line X7-X8 in FIG. 9. FIG. 11 is a schematic cross-sectional view taken along line X9-X10 in FIG. 9. Descriptions of configurations that overlap with the first embodiment will be omitted.

The liquid crystal display device 2-1 according to the second embodiment includes the first light blocking member 221M formed of a metal and a second light blocking member 222R formed of a resin. The first light blocking member 221M is formed of a metal, and the second light blocking member 222R is formed of a resin, so that the first light blocking member 221M and the second light blocking member 222R can be insulated from each other and made electrically independent of each other. Also in the second embodiment, display unevenness in a region of a display region AA which is adjacent to a frame region NA can be curbed. The first light blocking member 221M and the second light blocking member 222R may be in contact with each other.

As a material of the light blocking member formed of a resin, a resin composition or the like used as a material of a black matrix in the field of liquid crystal display devices can be used. The second light blocking member 222R can be formed by a known method such as photolithography, in which a photosensitive resin composition containing a black colorant and a resin component is applied to form a film, and then exposed to light and developed.

Examples of the resin component include acrylic resin, epoxy resin, epoxy acrylate resin, and the like. Examples of the black colorant include carbon black, titanium blacks such as titanium oxynitride and titanium nitride, and metal oxides such as iron oxide.

When the second light blocking member 222R is a light blocking member formed of a resin, the resistance of the second light blocking member 222R is preferably 10¹⁴ Ω/cm or more. With such a configuration, even when the first light blocking member 221M and the second light blocking member 222R are in contact with each other, they can be sufficiently insulated from each other. The upper limit of the resistance of the second light blocking member 222R may be, for example, 10¹⁶ Ω/cm. The resistance can be measured by a method according to JIS K 6911:2006.

From the viewpoint of simplifying the manufacturing process, a third light blocking member 223 is preferably a light blocking member 223R formed of a resin. FIG. 9 illustrates a case where the second light blocking member 222 and the third light blocking member 223 are the light blocking members 222R and 223R formed of a resin. As a material of the third light blocking member 223R, the same material as that of the second light blocking member 222R can be used, and the third light blocking member 223R is formed, for example, in a lattice shape by a known method such as photolithography. The order of forming the first light blocking member 221M, the second light blocking member 222R, and the third light blocking member 223R is not particularly limited, and any one of them may be formed first.

On the other hand, as described above, from the viewpoint of increasing the transmittance of a picture element and increasing contrast, the third light blocking member 223 may be the light blocking member 223M formed of a metal. The third light blocking member 223M may be formed of a material that is the same as or different from that of the first light blocking member 221M, but it is preferable to use the same material. For example, the first light blocking member 221M and the third light blocking member 223M may be patterned by the above-described method or the like, and then the second light blocking member 222R may be formed using the above-described resin material.

### Modification Example of Second Embodiment

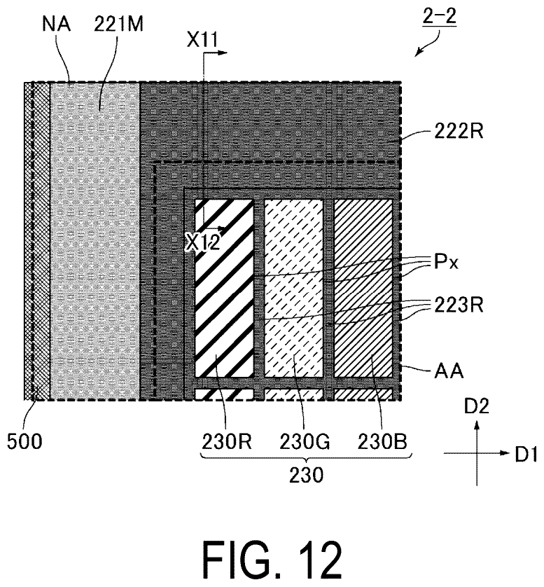

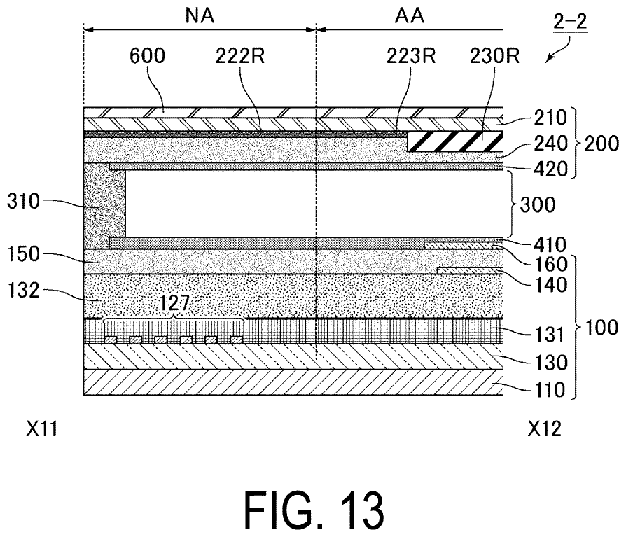

FIG. 12 is an enlarged schematic plan view of a corner portion of a liquid crystal display device 2-2 according to a modification example of the second embodiment. FIG. 13 is a schematic cross-sectional view taken along line X11-X12 in FIG. 12. A schematic cross-sectional view taken along the first direction D1 including the left frame region of the liquid crystal display device 2-2 is the same as that in FIG. 10, and thus is omitted. In the modification example of the second embodiment, a case where the second light blocking member 222 is a light blocking member 222M formed of a resin and the third light blocking member 223 is a light blocking member 223R formed of a resin will be described.

In the second embodiment, the first light blocking member 221M is disposed to surround the second light blocking member 222R, but in the modification example of the second embodiment, as illustrated in FIG. 12, the first light blocking member 221M may be disposed up to the upper end of the frame region along the vertical direction of the liquid crystal display device 2-2. The second light blocking member 222R may be disposed up to the upper end of the frame region while being adjacent to the first light blocking member 221M.

In the modification example of the second embodiment, the first light blocking member 221M, which is disposed to overlap the frame region in which the GDM is disposed, ground-connected, and formed of a metal, and the second light blocking member 222R formed of a resin are electrically independent of each other. In the modification example of the second embodiment, the first light blocking member 221M may be a light blocking member formed of a metal, the second light blocking member 222R may be a light blocking member formed of a resin, and the first light blocking member 221M and the second light blocking member 222R may be electrically independent of each other, which are not limited to the configuration illustrated in FIG. 12.

### EXAMPLES

The disclosure is described in further detail below using examples and comparative examples, but the disclosure is not limited to only these examples.

### Example 1

As a specific example of the first embodiment, a liquid crystal display device 1-1 according to Example 1 was manufactured. FIGS. 1 to 5 are diagrams of the liquid crystal display device according to Example 1.

A TFT substrate was manufactured by a method according to a method of manufacturing a TFT substrate of a general gate driver monolithic FFS mode. A gate metal layer was formed on a first support substrate 110. The gate metal layer includes a gate wiring line 120G and a gate electrode formed in a display region AA, gate electrodes 124 included in TFTs 2 and 3 formed in a TFT region GDM-TFT of a GDM, a plurality of bus lines 123 formed in a wiring line region GDM-BL, a fourth light blocking member 125 overlapping a light blocking member non-forming region in a plan view, and the like. Thereafter, a first insulating layer (gate insulating layer) 130 was formed using silicon nitride so as to cover the gate metal layer. A plurality of bus lines 123 may include gate lead-out wiring lines. The plurality of bus lines 123 and a plurality of bus lines 127 to be described later were formed of a layered film of copper and titanium.

After a semiconductor layer 121 for TFTs 1 to 3 was formed on the first insulating layer 130, a source metal layer was formed. The source metal layer includes a source wiring line 120S formed in a display region AA, a source electrode and drain electrode 120D, source electrodes 126 included in the TFTs 2 and 3 formed in a TFT region GDM-TFT of the GDM, the plurality of bus lines 127 formed in a wiring line region GDM-BL, a fourth light blocking member 128 overlapping the light blocking member non-forming region in a plan view, and the like. The plurality of bus lines 127 may include source lead-out wiring lines. Thereafter, a second insulating layer 131 was formed using silicon nitride so as to cover the source metal layer.

Thereafter, a third insulating layer 132 was formed using an acrylic resin, a counter electrode 140 was formed using a transparent conductive material on the third insulating layer 132 in the display region AA, and a fourth insulating layer 150 was formed using silicon nitride. Thereafter, a contact hole CH1 penetrating the second insulating layer 131, the third insulating layer 132, and the fourth insulating layer 150 was formed. A picture element electrode 160 was formed for each picture element, and the picture element electrode 160 was electrically connected to the drain electrodes 120D via the contact hole CH1. As described above, a gate driver monolithic TFT substrate was completed.

A CF substrate was manufactured by the following method. An example of a method of manufacturing the first to third light blocking members 221M, 222M, and 223M will be described below. In the following, a case where a layered body of tungsten and a nitride film is used as the materials of the first light blocking member 221M, the second light blocking member 222M, and the third light blocking member 223M will be exemplified. Specifically, a case where a four-layer layered body in which SiNx, W (tungsten), SiNx, and W are layered in this order is formed will be described. First, silicon nitride (SiNx) was layered on a glass substrate (second support substrate 210) by a chemical vapor deposition (CVD) method so as to have a thickness of 50 to 60 nm. Next, W was layered by a PVD method so as to have a thickness equal to or less than 10 nm. Thereafter, SiNx was layered by a CVD method so as to have a thickness of 40 to 50 nm. Finally, W was layered by a PVD method so as to have a thickness equal to or larger than 100 nm, thereby forming a four-layer layered body.

A resist was applied onto the four-layer layered body, the four-layer layered body was exposed to light and developed using a photomask designed to form the first to third light blocking members 221M, 222M, and 223M, and the four layers were collectively dry-etched, thereby forming the first to third light blocking members 221M, 222M, and 223M.

The above method is only an example, and for example, Siox or the like can also be used instead of SiNx as an insulating film used for a layered film as long as a film thickness is adjusted as appropriate. As a conductive film, Ti (titanium), Mo (molybdenum), or the like can be used instead of W. In the disclosure, a multilayer film of a transparent film and a metal has been exemplified, but in addition, for example, a conductive black inorganic material such as tantalum can be used, and for example, a combination of conductive films in which the surface of a layered body or the like, having silver oxide, silver, and silver oxide layered in this order, is a black material and a conductive material is disposed in the middle, can also be used.

Thereafter, a color filter layer 230 was formed in an optical opening surrounded by the third light blocking member 223M in the same manner as in a general color filter manufacturing method. Thereafter, an overcoat layer 240 was formed using an acrylic resin so as to cover the first to third light blocking members and the color filter layer. As described above, a CF substrate was completed.

Horizontal alignment films were formed on the surfaces of the TFT substrate and the CF substrate, and then a liquid crystal material was sealed between the TFT substrate and the CF substrate, thereby completing a liquid crystal panel. As the liquid crystal material, a liquid crystal material having a positive dielectric constant anisotropy (Δε=4.9) was used.

Thereafter, a transparent conductive layer 600 was formed on the entire surface (the surface on an observation face side) of the CF substrate on the side opposite to the liquid crystal layer by using ITO. Further, a conductive paste (silver paste) was applied to the sides other than a terminal region B, and the first light blocking member 221M, the conductive paste 500, and the transparent conductive layer 600 were electrically connected. Examples of a method of ground-connecting the first light blocking member 221M include (i) a method of connecting the transparent conductive layer 600 to a ground present in a drive circuit such as a printed circuit board assembly (PCBA) with a conductive tape as the conductive member 500, (ii) a method of connecting the ground present in the drive circuit such as a PCBA to a backlight bezel formed of a metal and connecting the backlight bezel and the transparent conductive layer 600, (iii) a method of connecting the ground present in the terminal region B and the transparent conductive layer 600 with the conductive paste 500, and the like. The first light blocking member 221M can be ground-connected by electrically connecting the ground present in the drive circuit, the backlight bezel, the terminal region B, or the like to the transparent conductive layer 600 by the methods (i) to (iii) described above.

A surface resistivity and line width for each wiring line of the plurality of bus lines 123 and 127, and a dielectric constant and thickness of each insulating layer are summarized in Table 1 below. In the drawing, the thickness of the first insulating layer 130 is indicated by T₁₃₀, the thickness of the second insulating layer 131 is indicated by T₁₃₁, the thickness of the third insulating layer 132 is indicated by T₁₃₂, the thickness of the fourth insulating layer 150 is indicated by T₁₅₀, the thickness of the liquid crystal layer 300 is indicated by T₃₀₀, the thickness of the overcoat layer 240 is indicated by T₂₄₀, and the thickness of the color filter layer 230 is indicated by T₂₃₀.

TABLE 1

| | | Physical | | Line width | | |
|---|---|---|---|---|---|---|
| | | properties | | or thickness | | |
| | | Surface | 0.13 | Line | | |
| Plurality of bus lines 123, 127 | | resistivity | Ω/□ | width | 4 μm | |
| Capacitance | First insulating | Relative | 6.9 | Thick- | 0.515 | μm |
| | layer 130 | dielectric | | ness | | |
| | Second | constant | | | | |
| | insulating layer | | | | | |
| | 131 | | | | | |
| | Third insulating | | 4 | | 2 | μm |
| | layer 132 | | | | | |
| | Fourth | | 6.9 | | 0.2 | μm |
| | insulating layer | | | | | |
| | 150 | | | | | |
| | Liquid crystal | | 3.5 | | 3 | μm |
| | layer 300 | | | | | |
| | Overcoat layer | | 4 | | 2 | μm |
| | 240 | | | | | |
| | Color filter | | 4 | | 2.5 | μm |
| | layer 230 | | | | | |

### Comparative Example 1

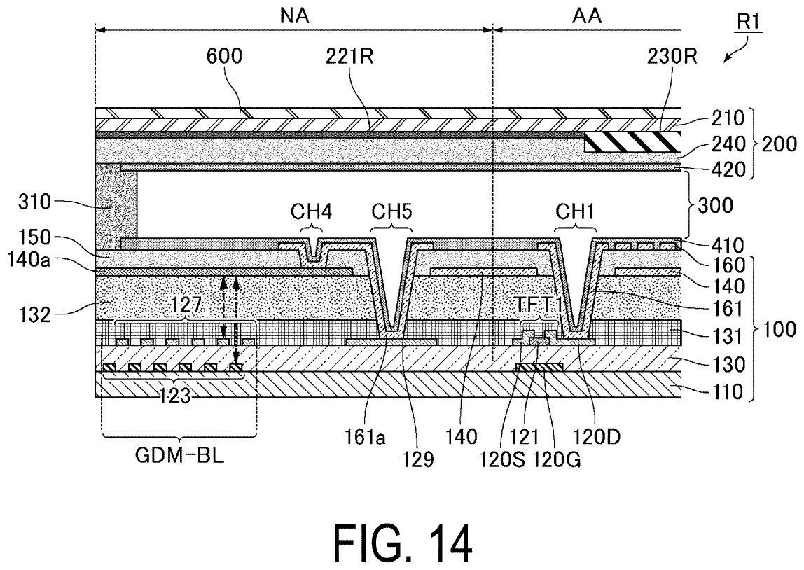

FIG. 14 is a schematic cross-sectional view of a liquid crystal display device R1 according to Comparative Example 1. FIG. 14 corresponds to a schematic cross-sectional view taken along line X1-X2 of a corner portion of the liquid crystal display device illustrated in FIG. 4. As illustrated in FIG. 14, in the liquid crystal display device R1 according to Comparative Example 1, a light blocking member 221R formed of a resin is disposed to be connected to a frame region NA and a display region AA, and the light blocking member 221R and a red color filter 230R are in contact with each other.

In Comparative Example 1, shield electrodes 140a were formed on a TFT substrate 100 using ITO so as to overlap a TFT region GDM-TFT and a wiring line region GDM-BL of a GDM. The shield electrodes 140a may be formed at the same time when counter electrodes 140 are formed on a third insulating layer 132. After a fourth insulating layer 150 was formed on the counter electrodes 140 and the shield electrodes 140a, a contact hole CH4 penetrating the fourth insulating layer 150 and a contact hole CH5 penetrating a second insulating layer 131, a third insulating layer 132, and the fourth insulating layer 150 were formed. In Comparative Example 1, a dummy picture element having no picture element electrode 160 disposed therein is disposed near a boundary between the display region AA and a frame region NA. The shield electrodes 140a are electrically connected to source wiring lines 129 by contact electrodes 161a via the contact holes CH4 and CH5. With such a configuration, in Comparative Example 1, the same common potential as that of the counter electrode 140 is applied to the shield electrode 140a, and thus it is possible to prevent a gate voltage from leaking to a second substrate 200 side. In Comparative Example 1, the transparent conductive layer 600 is provided on the surface of the second substrate 200 on the side opposite to the liquid crystal layer 300, but the transparent conductive layer 600 and the shield electrodes 140a are not electrically connected, and the transparent conductive layer 600 is frame-grounded or grounded.

### Comparative Example 2

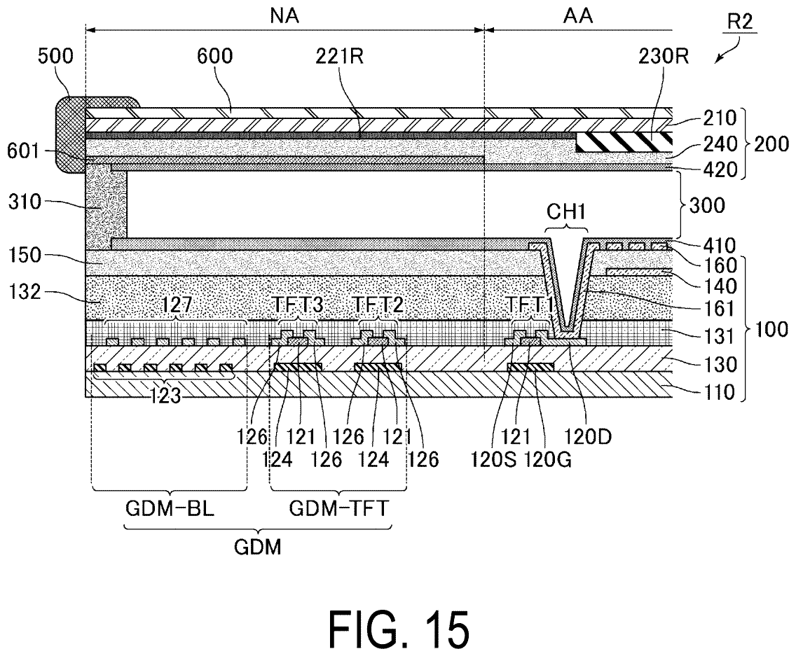

FIG. 15 is a schematic cross-sectional view of a liquid crystal display device R2 according to Comparative Example 2. FIG. 15 corresponds to a schematic cross-sectional view taken along line X1-X2 of the corner portion of the liquid crystal display device illustrated in FIG. 4. As illustrated in FIG. 15, in Comparative Example 2, as in Comparative Example 1, a light blocking member 221R formed of a resin is disposed to be connected to a frame region NA and a display region AA, and the light blocking member 221R and a red color filter 230R are in contact with each other.

In the liquid crystal display device R2 according to Comparative Example 2, shield electrodes 601 were formed of ITO on a liquid crystal layer 300 side of a second substrate 200 (on an overcoat layer 240 in FIG. 15) so as to overlap a region where a GDM was formed in a plan view. As in Example 1, a transparent conductive layer 600 was formed of ITO on the surface of the second substrate 200 opposite to the liquid crystal layer 300. A conductive paste 500 was applied to the side surface of the second substrate 200, and the transparent conductive layer 600 and the shield electrodes 601 were electrically connected to each other via the conductive paste 500.

### Comparative Example 3

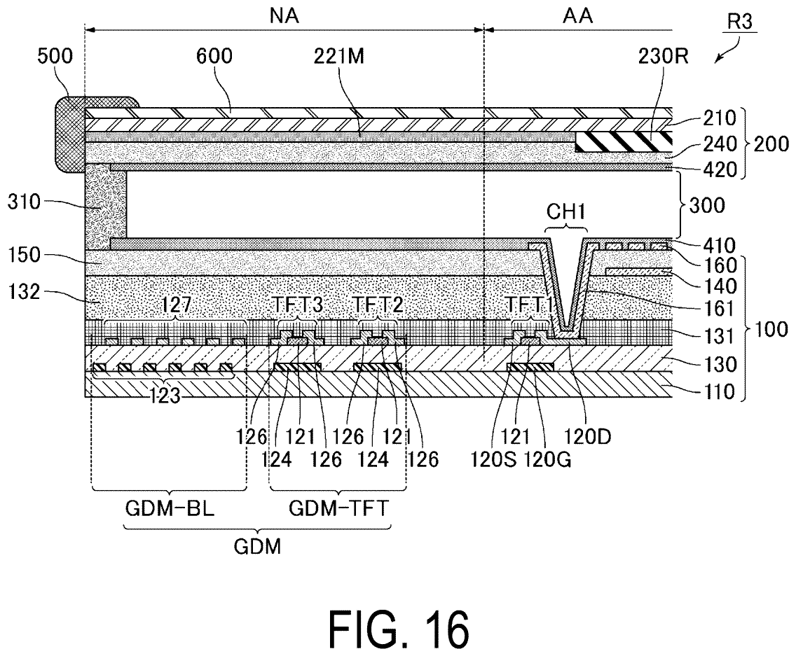

FIG. 16 is a schematic cross-sectional view of a liquid crystal display device R3 according to Comparative Example 3. FIG. 16 is a schematic cross-sectional view taken along line X1-X2 of the corner portion of the liquid crystal display device illustrated in FIG. 4. In Comparative Example 3, a light blocking member 221M formed of a metal is disposed to be connected to a frame region NA and a display region AA, and the light blocking member 221M and a red color filter 230R are in contact with each other. Comparative Example 3 has the same configuration as that of Example 1 except that no interval is provided between a light blocking member overlapping the frame region NA and a light blocking member overlapping the display region AA, and that a fourth light blocking member 125 (see FIG. 4) is not provided on a TFT substrate side.

### Time Constant

Table 2 below shows a capacitance and resistance for each wiring line of the plurality of bus lines disposed in the frame regions in Examples 1 and 2 and Comparative Examples 1 and 2. A time constant represented by a product of a resistance for each wiring line and a capacitance for each wiring line is also described. The capacitance and the resistance can be calculated from the surface resistivity, the relative dielectric constant, and the design data.

TABLE 2

| | Comparative | | Comparative | | Example 1 and | |
|---|---|---|---|---|---|---|
| | Example 1 | | Example 2 | | Example 2 | |
| Resistance for each | 4.82 | kΩ | 4.82 | kΩ | 4.82 | kΩ |
| wiring line | | | | | | |
| Capacitance for each | 26.32 | pF | 8.68 | pF | 4.81 | pF |
| wiring line | | | | | | |
| Time constant | 0.13 | μsec | 0.04 | μsec | 0.02 | μsec |
| (resistance × capacitance) | | | | | | |

As shown in Table 2, in Comparative Example 1, the capacitance for each bus line wiring line is large, and thus the time constant is larger than those in Examples 1 and 2. When the configurations in Comparative Example 1 and Examples 1 and 2 are compared, in Comparative Example 1, the shield electrodes 140a are formed on the TFT substrate 100 side, and distances between the shield electrodes 140a and the plurality of bus lines 123 and 127 in Comparative Example 1 indicated by dotted double-headed arrows in FIG. 14 are shorter than distances between the first light blocking members 221M and the plurality of bus lines 123 and 127 in Example 1 indicated by dotted double-headed arrows in FIG. 4. For this reason, in Comparative Example 1, a larger electrostatic capacitance is formed between the shield electrodes 140a and the plurality of bus lines 123 and 127 than in Examples 1 and 2, and consequently, the waveform of a scanning signal is likely to become dull. The dullness of the waveform can be confirmed by an oscilloscope or the like.

Hereinafter, a case where display is performed in 4K full high definition (QFHD) having a resolution of 3840× 2160 pixels will be described. When 60 Hz driving of the related art is performed, a gate-on time of approximately 7 usec can be secured even in Comparative Example 1, and thus the influence of a large time constant is small. However, when high-frequency driving of 600 Hz is performed frequency in a QFHD mode, a gate-on time of only approximately 1 usec is secured in Comparative Example 1, and thus the waveform of a scanning signal of the TFT 1 disposed for each picture element becomes dull, the TFT 1 is insufficiently charged, and a desired voltage cannot be applied to the corresponding picture element.

On the other hand, in Examples 1 and 2, the first light blocking member 221M, which is a light blocking member formed of a metal, is disposed on the second substrate 200 side. Since the distances between the first light blocking member 221M and the plurality of bus lines 123 and 127 are longer in Examples 1 and 2 than in Comparative Example 1, a time constant for each bus line wiring line in Examples 1 and 2 could be reduced to approximately ⅙ of that in Comparative Example 1. In Examples 1 and 2, even when the liquid crystal display device was driven at a frequency of 600 Hz, the waveform of a scanning signal did not become dull, and the TFT 1 disposed in the display region was sufficiently charged. In Comparative Example 2, a time constant could be reduced as compared with Comparative Example 1, but the time constant was larger than those in Examples 1 and 2.

### Examination of Display Unevenness

In Examples 1 and 2 and Comparative Examples 1 and 2, when black display was set to 0 gray scale and white luminance (the highest luminance state) was set to 256 gray scales, picture elements of all colors were lit at the same luminance to perform gray halftone display at 64 gray scales. Monochrome highlighting display was performed such that only blue picture element overlapping a blue color filter was lit at the maximum luminance, and a red picture element overlapping a red color filter and a green picture element overlapping a green color filter were set to 0 gray scale. Specifically, an alternating voltage of +16 V and an alternating voltage of −12 V were applied at 600 Hz as gate voltages from the gate driver to the gate lead-out wiring line. That is, a difference in level ΔVg of a voltage applied to the gate wiring line was set to 28 V. From a source driver to a source lead-out wiring line, an alternating voltage of +2 V and an alternating voltage of −2 V were applied at 600 Hz as source voltages in the case of halftone display, and an alternating voltage of +5.7 V and an alternating voltage of −5.7 V were applied in the case of highlighting display.

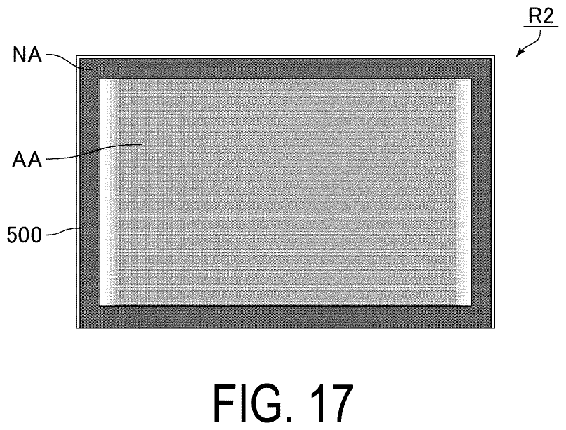

FIG. 17 is a schematic plan view illustrating display unevenness occurring in the liquid crystal display device according to Comparative Example 2. As illustrated in FIG. 17, in Comparative Example 2, when halftone display was performed, display unevenness in which the outer edge of the display region along the longitudinal direction of the liquid crystal display device became whitish was observed. In Comparative Example 2, when the highlighting display was performed, whiteness of a region of the display region AA which is adjacent to the frame region NA in which the GDM was further disposed was conspicuous, and display unevenness was clearly observed.

When the above-mentioned display unevenness is examined, it is considered that the light blocking member 221R formed of a resin in Comparative Example 2 is charged by repeatedly applying a high voltage of ΔVg=28 V to the gate driver monolithic (GDM). Since the light blocking member 221R formed of a resin is connected to the frame region NA and the display region AA, it is considered that an unintended vertical electrical field is generated between the charged light blocking member 221R formed of a resin and the picture element disposed in the display region AA in a region of the display region AA which is adjacent to the frame region NA in which the GDM is disposed. It is considered that the alignment of the liquid crystal molecules in the liquid crystal layer 300 was disturbed due to the vertical electrical field, and the region of the display region AA adjacent to the frame region NA appeared whiter than the central portion of the display region AA when halftone display and highlighting display were performed.

On the other hand, in Examples 1 and 2 and Comparative Example 1, no display unevenness was observed in both the halftone display and the highlighting display. It is considered that, in Examples 1 and 2, similarly to Comparative Example 2, the first light blocking member 221M was charged, but the charge could be removed because the first light blocking member 221M was grounded via the conductive paste 500 and the transparent conductive layer 600, and thus the display unevenness could be curbed. The shield electrodes 601 formed of ITO in Comparative Example 2 have a surface resistance of several k Q, whereas the surface resistance of the first light blocking member 221M formed of a metal in Examples 1 and 2 is approximately several Ω□, and electricity easily flows from the surfaces. For this reason, it is considered that the color filters were prevented from being charged in Examples 1 and 2 as compared with Comparative Example 2. It is considered that, in Comparative Example 1, the shield electrodes disposed on the TFT substrate side could prevent the color filter from being charged.

### Transmittance

A transmittance was measured for Examples 1 and 2 and Comparative Examples 1 to 3, and the transmittances for Examples 1 and 2 and Comparative Examples 2 and 3 when the transmittance for Comparative Example 1 was set to 100% is summarized in Table 3 below. A 14-inch module (liquid crystal panel) was prepared, and the white luminance of the liquid crystal panel was measured at the center of the liquid crystal panel with a spectroradiometer by applying±5.7 V as the gate voltage and the source voltage to the module. Thereafter, the luminance of the backlight at the same position was measured, and a transmittance was calculated by transmittance=white luminance of liquid crystal panel/luminance of backlight.

TABLE 3

| | | | | | |
|---|---|---|---|---|---|
| | Comparative | Comparative | Comparative | Example | Example |
| | Example 1 | Example 2 | Example 3 | 1 | 2 |
| Transmittance | 100% | 100% | 95% | 100% | 100% |
| when Comparative | | | | | |
| Example 1 is 100% | | | | | |

As shown in Table 3, the transmittances for Examples 1 and 2 and Comparative Example 2 were equivalent to that for Comparative Example 1, whereas the transmittance for Comparative Example 3 was low. In Comparative Example 3, it is considered that, since the light blocking member 221M formed of a metal and disposed to be connected to the frame region NA and the display region AA is ground-connected, a vertical electrical field was generated between the light blocking member 221M and the picture element electrode 160, and the transmittance was reduced.

On the other hand, in Example 1, the first light blocking member 221M overlapping the GDM is ground-connected, and the second light blocking member 222M is disposed with an interval from the first light blocking member 221M. In Example 2, the second light blocking member 222R is formed of a resin, and thus the second light blocking member 222R is electrically independent even when it is in contact with the ground-connected first light blocking member. For this reason, in Examples 1 and 2, it is considered that no vertical electrical field was generated between the second light blocking members 222M and 222R and the picture element electrodes 160 of the TFT substrate 100, and a high transmittance was obtained.

From the above examination, in Comparative Example 1, since the shield electrodes 140a formed of ITO and having a common potential applied thereto were disposed on the TFT substrate 100, the color filter layer 230 could be prevented from being charged, but a time constant became large. Thus, the waveform became dull in the case of high-frequency driving, and the TFT 1 was insufficiently charged. In Comparative Example 2, although a time constant could be reduced, the resistance of the shield electrode 601 formed of ITO disposed on the second substrate 200 was high, and thus the charging of the color filter layer 230 could not be sufficiently curbed. In Comparative Example 3, an unnecessary vertical electrical field was generated between the picture element electrode 160 and the light blocking member 221M formed of a metal and disposed to be connected to the frame region NA and the display region AA, and the transmittance was low.

On the other hand, in Examples 1 and 2, the ground-connected first light blocking member 221M formed of a metal and the second light blocking member were electrically independent of each other, and thus it is possible to obtain a liquid crystal display device capable of curbing the occurrence of display unevenness in a region of the display region AA which is adjacent to the frame region NA, being sufficiently charged even in high-frequency driving, and having a high transmittance.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A liquid crystal display device comprising:
a first substrate;
a second substrate; and
a liquid crystal layer sandwiched between the first substrate and the second substrate,
wherein the first substrate includes a display region and a frame region disposed around the display region,
a first wiring line extending in a first direction, a second wiring line extending in a second direction intersecting the first direction, a picture element electrode electrically connected to the second wiring line via a switching element, and a counter electrode facing the picture element electrode are disposed in the display region,
a driver circuit connected to the first wiring line is disposed in the frame region,
the second substrate includes a first light blocking member disposed overlapping the frame region in a plan view and overlapping at least the driver circuit, a color filter layer including a plurality of color filters disposed overlapping the display region, and a second light blocking member disposed between the first light blocking member and the color filter layer,
the first light blocking member is a light blocking member formed of a metal and is ground-connected, and
the first light blocking member and the second light blocking member are electrically independent of each other.

2. The liquid crystal display device according to claim 1,
wherein the first light blocking member and the second light blocking member are disposed with an interval therebetween.

3. The liquid crystal display device according to claim 2,
wherein the second light blocking member is a light blocking member formed of a metal.

4. The liquid crystal display device according to claim 1,
wherein the second substrate further includes a third light blocking member disposed between the plurality of color filters in a plan view, and
the third light blocking member is a light blocking member formed of a metal.

5. The liquid crystal display device according to claim 1,
wherein the second substrate further includes a third light blocking member disposed between the plurality of color filters in a plan view, and
the third light blocking member is a light blocking member formed of a resin.

6. The liquid crystal display device according to claim 2,
wherein the first substrate further includes a fourth light blocking member disposed overlapping a region between the first light blocking member and the second light blocking member disposed with an interval therebetween in a plan view.

7. The liquid crystal display device according to claim 1,
wherein the second light blocking member is a light blocking member formed of a resin.

8. The liquid crystal display device according to claim 7,
wherein the first light blocking member and the second light blocking member are in contact with each other, and
the second light blocking member has a resistance of 10¹⁴ Ω/cm or more.

9. The liquid crystal display device according to claim 1,
wherein the second substrate includes a conductive member electrically connected to the first light blocking member.

10. The liquid crystal display device according to claim 9,
wherein the second substrate includes a transparent conductive layer electrically connected to the conductive member on the surface opposite to the liquid crystal layer.
